(19) United States
(12) Patent Application Publication
(10) Pub. No.: US 2016/0138818 A1
(43) Pub. Date: May 19, 2016

(54) HUMIDIFIER AND ATOMIZER MODULE

(71) Applicant: BONECO AG, Widnau (CH)

(72) Inventors: Manfred Fitsch, Bludenz (AT); Arben Ndue, Bischofszell (CH)

(21) Appl. No.: 14/901,741

(22) PCT Filed: Jul. 3, 2014
(86) PCT No.: PCT/CH2014/000095

§ 371 Date: Jan. 15, 2016

(30) Foreign Application Priority Data
Jul. 4, 2013 (CH) 1209/13
Nov. 13, 2013 (CH) 1899/13

(51) Int. Cl. F24F 6/12; C02F 1/32

(52) U.S. Cl. CPC F24F 6/12; C02F 1/325; F24F 2006/006

(57) ABSTRACT

An atomizer-humidifier includes a water reservoir and an atomizer module. The atomizer module has an atomizer housing and an oscillation element that can be induced to oscillate and which, in the normal mode of the humidifier, is covered by water. The humidifier also includes a device for supplying water from the water reservoir to a water receiving zone above the atomizer module. The atomizer module has at least one ultraviolet light source fastened to the atomizer module housing.

### BACKGROUND OF THE INVENTION

1. Field of the Invention

The invention relates to an air humidifier as well as to a transducer module for a humidifier.

2. Description of Related Art

A principle that is applied by many air humidifiers for humidifying air of interiors is the nebuliser or atomiser principle. With such nebulisers, a transducer platelet, which is excited into ultrasound oscillation and which is covered by water is applied, for example, for producing a mist of tiny water droplets.

However, such nebulisers have the disadvantage that germs present in the water are co-nebulised. A very frequent exchange of the water reserve accompanied by a thorough cleaning of the water container is therefore necessary.

It is known to provide preparations for the water container, which release silver ions to the water and in this manner act in an anti-bacterial manner. However, the effect of silver preparations also has its limits, and occasionally there are reservations concerning the use of silver, in particular in the case that the silver gets into the waste water and can negatively influence the bacteria that is there in waste water treatment plants.

For this reason, humidifiers that operate in a manner directed to sterilisation by way of irradiation with ultraviolet radiation, specifically with UVC light, have been suggested in more recent times.

However, the designers of such air humidifiers are faced with the challenge of arranging the radiation source such that it effectively sterilises at least a predominant part of the fluid to be atomised, and at the same time of economically using the resources and also of not rendering the effort for the manufacture of the humidifier too large.

U.S. Pat. No. 4,630,475 discloses a humidifier with a water tank, wherein the water tank includes a window, through which it can be illuminated. An ultraviolet lamp can be used for irradiating the water in the tank, which, according to the authors, is to prevent the growth of bacteria in the tank as well as in the atomising chamber.

U.S. Pat. No. 5,859,952 discloses a humidifier with a water tank, with a water dispersion unit and with a conduit therebetween. A UV lamp is arranged such that the water in the conduit is irradiated by UV on the way from the tank to the dispersing unit. The dispersing unit is a vaporiser but can also be an ultrasound atomiser or an evaporator.

US 2013/0249126 discloses an atomiser humidifier with an annular outflow body. Water from the water tank goes past a UV light source, which is arranged in a tube, into a water reservoir. Two ultrasound transducers, which atomise the water, are present on the side of the water reservoir that lies opposite the tube. US 2013/0249126 therefore likewise teaches the sterilisation of water to be atomised, on the way from the tank to the dispersing unit.

The sterilisation of the water in the water tank or in the conduit to the water receiver of the dispersion unit has the disadvantage that germs, which are not affected by the sterilisation, can likewise form in this water receiver. This is of particular significance if a longer idle period is effected between two applications of the humidifier.

Amongst others, KR 2012 0040513 discloses an atomiser humidifier, with which a UV source, which is arranged after the dispersion unit and in its own manner above the dispersing unit, is present. The atomiser humidifier according to KR 2012 0040513 is provided with two UV-LED modules. A first UV LED module is located in the outlet and sterilises the already nebulised water in the outlet. A second UV-LED module with a light-conductive rod is located in the water tank. Also KR 2005 102317 shows UV-LEDs above the ultrasound atomiser.

WO 2008/002123 shows an atomiser humidifier for installation into a ceiling. The humidifier has two housing parts, of which an upper housing part is fastened on the ceiling, and carries the actual atomiser, and a lower housing part is designed as a water vessel that is fastened on the upper housing part and can be removed from this in a tool-free manner. This document mentions the possibility of attaching a UV lamp in the proximity of the water reservoir, in order to irradiate the fluid in the reservoir as well as the air in its proximity. Specifically, the UV lamp is fastened on a rod that carries the atomiser, and which therefore belongs to the upper housing part

Approaches with separately installed LED modules above the atomiser although per se provide the possibility of solving the problems mentioned above, by way of the already atomised water being directly sterilised, however, in order to be effective, the UV light source instead during the operation must be operated in a continuous manner and with a comparatively high intensity. Moreover, the assembly is not trivial and necessitates electrical feed-throughs for the light source to the outlet region which is above the atomiser and which is wet on operation. This entails the necessity of a completely new housing design in comparison to existing humidifiers.

The principle of sterilisation or of the water to be atomised in atomiser humidifiers by way of ultrasound radiation has not become established unit now, probably due to the disadvantage of the existing principles.

### SUMMARY OF THE INVENTION

It is an object of the present invention, to provide an atomiser humidifier that overcomes disadvantages of the state of the art and that permits an effective sterilisation of the atomised water.

The humidifier includes a water store and a nebuliser module with an oscillation element (for example, an oscillation plate), which can be excited into ultrasound oscillation. The oscillation element is thereby covered by water in normal operation of the humidifier. The water-filled region above the oscillation module is hereafter called “water receiving region”. By way of suitable means, it is ensured that water flows out of the water store into the water receiving region, in order to keep the covering of the oscillation element with water roughly constant. This is effected without a pump in most embodiments, such that the water level of the water receiving region, which is held in a roughly constant manner, is lower or does not lie significantly higher than the base of the water tank.

The oscillation element, for example, includes an oscillation exciter (it can consist of this or yet includes further elements, for example an oscillation body of another material, which can be excited into oscillation). The oscillation exciter is designed for example as a transducer, in particular a sonic transducer, for example piezo-transducer. An excitation signal, which is formed according to the desired oscillation, is to be applied at the oscillation exciter.

According to an aspect of the invention, at least one light source for producing ultraviolet light is moreover arranged such that it couples light into the water receiving region, and specifically from a position below the water level (the plane of the water surface). Generally, this means that the at least one light source is at least partly covered by water in the water receiving region in normal operation. Accordingly, the at least one light source is arranged in particular below the water receiving region or laterally on the water receiving region. In principle, it is also possible for the light source itself to be arranged above the water level and to be connected to the water in the water receiving region via fibre-optics, wherein a light coupling-in point, at which the light is coupled from the fibre-optic into the water in the water receiving region, lies below the water level, i.e. in a lower or lateral delimitation of the water receiving region.

As is known per se, a normal operation water level (water height) of the water in the water receiving region is a characteristic of the humidifier as such. The water level can be controlled by way of passive or active control means. Passive control means, for example, can include a float, which closes a feed flow from the water store on reaching a certain water level, or they can operate, for example, according to the so-called chicken drinking trough principle. Active control means can operate with a measurement of the water level or with a sensor operating in the “on/off” operation.

On account of the procedure according to the invention, the UV light source is arranged such that it is directly coupled onto the water above the oscillation element. This results in advantages concerning the effectiveness of the sterilisation, in particular in contrast to the attachment in the conduit or in the water tank, since water behind the conduit is not sterilised in the latter cases, i.e. if germs form there given longer standstills, these are then co-atomised on starting operation. A further advantage results concerning the energy consumption, and specifically compared to an arrangement in the tank demanding a relatively high radiation power for a sterilisation of the whole tank, as well as in comparison with the arrangement in the outlet, since only a small quantity of water is irradiated in the latter case and a relatively high irradiation power must be constantly present due to the short sojourn time of the water droplets.

A physical effect can also be utilised in a positive manner by way of the arrangement of the radiation source below the water level, thus below the water, specifically the effect that radiation coupled into a medium with a higher refractive index (water), given an oblique incidence onto a boundary surface to a medium with a lower refractive index (air), is at least partly reflected back into the medium. In other words, the effect of the radiation is additionally increased due to internal reflections in the water, in comparison to the arrangement in the outlet, i.e. to a fictive irradiation from “above”. This effect is particularly high, since the refractive index difference water-air in the UVC range is greater than with visible light.

Accordingly, one can envisage the light source(s) being arranged such that it/they illuminates/illuminate the part of the water surface, from which the droplets detach (i.e. in particular the water surface lying directly above the oscillation element), from below, and this also includes illumination obliquely from below, for example also by light sources that are arranged laterally in or on a side wall of the water receiving region and have broad radiation emission characteristics.

In embodiments, the UV light can be coupled into the water receiving region through at least one lateral window element lying below the water level.

Moreover, it has been found that it can be particularly advantageous if the water receiving region is roughly beaker-like with a peripheral side wall and with the water level below the beaker edge, and if the light source beams through a window in this peripheral side wall into the water receiving region.

This advantage in particular is due to the following reason: efficient UVC light sources, inasmuch as they are designed as reliable LEDs with a long service life, are expensive, and the electricity consumption can also be significant. For this reason, it is advantageous if a desired sterilisation effect is realised by as few as possible light sources, which if possible are not too large. For this reason, it can be advantageous if the volume in the water receiving region and which is to be sterilised is not too large, since otherwise too much radiation power is required for a given volume to be sterilised. However, it has been found that the height of the water level has an influence on the atomisation characteristics and cannot be freely selected, and that a small volume in particular is achieved by an as small as possible diameter of the light receiving region and by an opening angle of the beaker-like volume which where possible, is not too large. A particularly small volume can be achieved with an arrangement of the light source along the side due to the fact that the light source takes up no space in the base area of the beaker-like volume in the case of beaming-in from the side.

The side wall of the beaker-like volume under the aspects described above—and this relates to all embodiments with beaker-like water-receiving regions—can have an average angle to the vertical of for example 30° at the most, in particular 20° at the most and for example 10° at the most, below the water level. In particular it can be essentially vertical.

The side wall of the beaker-like volume can additionally or alternatively be essentially circularly cylindrical or—if the side wall is at an angle to the vertical—can be conical; and combinations of conical and vertical sections are also possible.

In embodiments, it can also be advantageous if a water reservoir region is present additionally to the water receiving region, wherein the post-flowing of the water is effected out of the water store into this water reservoir region, and wherein the water reservoir region is connected to the water receiving region in the manner of communicating vessels (i.e. a passage below the water level exists) and therefore the water levels in the water reservoir region and the water receiving region are always equal.

This further measure has the following advantage. With small volumes in the water receiving region, the problem of fluctuations of the water level can result, depending on the mechanism, with which water is post-fed out of the water tank (water store). Fluctuations of the water volume effect relatively significant fluctuations of the water level in the case of a base area which—as is advantageous under certain circumstances as has been discussed above—is as small as possible. Such fluctuations however result automatically with mechanisms based on the chicken drinking trough principle for example, since the air post-flows into the water tank only in relatively large portions on account of surface tension effects and as a result the water only flows out of the water tank in corresponding portions. The base area can accordingly be designed larger without the water receiving region having to be made larger, by way of the provision of a water reservoir region. The apparent conflict of aims between an efficient sterilisation (small volume of the water receiving region) and an avoidance of larger water level fluctuations (large volume) can therefore be solved in an elegant manner.

In particular, one can envisage the base area of the water reservoir region and of possible further water-filled regions that lie further outside the water receiving region and are communicatingly connected to this water receiving region in a direct or indirect manner, at the height of the average water level corresponding at least to the respective base area of the water receiving region, and for example being a multiple of this, for example at least double this, at least triple this or at least fourfold.

The passage between the water reservoir region on the one hand and the water receiving region on the other hand must be large enough for as much water to be able to post-flow, as is atomised, at all times. On the other hand, it should be small enough, in order to effectively decouple the water receiving region as its own region, from the water reservoir region, so that significant quantities of unsterilised water do not get into the water receiving region due to diffusion for example during a brief interruption of the irradiation. Generally, the diameter of the passage at least at its narrowest location is significantly smaller that a surface area of the oscillating element; and for example it can be maximal 2 cm² or maximal 1 cm² or maximal 0.5 cm² or 0.2 cm² or even less.

The light source can for example be a lamp that is based on the principle of gas discharge—for example as a mercury vapour lamp—and as such in particular it can have the shape of a tube, but other shapes are also not ruled out.

Alternatively, the at least one light source can be a light diode, in particular a UV light diode (LED). Several light diodes can also be present.

Other light sources such as UV super-luminescent diodes, UV laser diodes, arc lamps, etc., are also not ruled out. Combinations of the mentioned light sources, for example combinations of UV-LEDs with UV gas discharge lamps are likewise possible.

The emission spectrum of the light source is preferably selected such that at least a part of the irradiated light is in the UVC range, i.e. below 280 nm, in particular between 100 nm and 280 nm. Light in this frequency range has the capability of destroying DNA and thus also germs as such. At least half of the radiation power is released by the light source in the UVC range, in embodiments.

A control of the light source(s) can be configured such that it illuminates in permanent operation in the case of the oscillation element being switched on. Other operational modes can also be programmed, for example an operation of the light source only on switching-on and then for a certain time at regular time intervals.

In a group of embodiments, the arrangement of the light source(s) and their coupling to the water receiving region is such that the light is emitted roughly from the plane of the oscillation element. The radiation emitting characteristic can be such that the radiation is emitted upwards with regard to gravity, or, for example with a peripheral arrangement of the light source(s), is emitted upwards and to the middle.

According to an alternative, the light source/the light sources, which is to say the light coupling-in point, is arranged along a side wall of the water receiving region. The radiation emitting characteristics can be such that the light is primarily radiated to the middle, wherein broad radiation emitting characteristics can be selected.

Common to both alternatives is the fact that light is emitted from the outside, which is to say from a delimitation of the water receiving region, into this, in particular through a window. This has been found to be advantageous with regard to the contacting of the light source and to the prevention of contact between parts which are subjected to current on the one hand and the water on the other hand.

Combinations are also conceivable, in particular with the use of more than one light source.

That the light in embodiments is emitted “roughly from the plane or the oscillation element” can mean that the light source (more precisely: the location in the light source where the light is predominantly produced) is not arranged above the plane or at the mostly slightly above the plane, for example by 1 cm at the most. The light source can also have a greater vertical distance to this plane in other embodiments—in particular with light sources or light in-coupling points at the side.

In embodiments, the light source or the light sources (or light coupling-in point(s)) is/are distributed in the peripheral direction. With the use of UV LEDs as light sources, these for example can be distributed in the peripheral direction at regular angular intervals, for example in intervals of 120° with the use of 3 LEDs or of 90° with the use of 4 LEDs.

The light source (for example if it is designed as a tube) or the light sources can accordingly surround the oscillation element in a ring-like manner, given an arrangement roughly in the plane of the oscillation element. In the case of several light sources, the light sources for this can be arranged at roughly the same distance to the axis and in a uniformly distributed manner in the peripheral direction about the oscillation element. The use of several light sources instead of only one can be preferred, for example with the use of LEDs or small gas discharge lamps.

In the latter case, with the presence of a window element, this can be annular, i.e. form a ring around the oscillation element. Alternatively, several window elements can also be present, for example one window per light source.

The light source can thereby be fastened on the nebuliser module housing in a direct manner or via a carrier, and can be part of the nebuliser module.

The nebuliser housing defines a first side, which faces the water and which on normal operation generally corresponds to the upper side, and a second side, which is away from the water (generally the lower side), wherein the first and the second side are separated from one another in a water-tight manner. The nebuliser module housing on the second side, for example, can carry an electronics module which produces the excitation signal. The excitation signal is led through the housing via watertight feed-throughs and applied to the oscillation exciter. Such an electronics module however can also be arranged in the humidifier separately from the housing and be connected to the nebuliser module via electrical leads and be connected to feed-throughs there.

Of course, it is also possible to arrange different elements of the electronics module at different locations, for example on different circuit boards.

According to a further aspect of the invention, the at least one light source for the production of ultraviolet light is then arranged on the nebuliser module such that contacted from the second side, it emits ultraviolet light toward the first side from below into the water receiving region.

According to a first possibility, the at least one light source is moulded in a water-tight manner and is fastened on the first side of the nebuliser module housing and connected to the second side via electrical feed-throughs for example. These feed-throughs can be feed-throughs, through which the excitation signal is led (in separate electrical leads) or be feed-throughs provided specifically for the light source.

According to a second possibility, the at least one light source is arranged on the second side of the housing, and the nebuliser model comprises at least one transparent window element, which is sufficient for the ultraviolet radiation, forms a part of the nebuliser module housing and is connected in a water-tight manner to the non-transparent (for example metallic) housing part(s). A circuit board, which is assembled on the nebuliser module housing, for example, can serve as a carrier of the light source(s) in these embodiments.

Moreover, an arrangement with which the light for example can be emitted laterally and upwards roughly from the plane of the oscillation element for example can be achieved in a particularly simple manner by way of the possible attachment of the light source(s) on the housing of the nebuliser module. Light components, which are emitted upwards and which are not reflected back into the water, get into the outlet and effect an irradiation of the water droplets on their way upwards, essentially over their complete path. This additionally contributes to the effectiveness.

A further advantage results with the installation and manufacture. The light source in embodiments is an integral component of the nebuliser module. This can be inserted into the housing of the humidifier as a whole. Neither additional openings in the humidifier housing for the electrical contacting of the light source, nor further sealing etc. are required. Existing humidifier designs can be adopted.

Electric feed-throughs, which are necessary for the light source, on manufacture of the nebuliser module, can be created together with the feed-throughs for the oscillation exciter, which are necessary in any case, and for example be sealed off with a curing cast mass. With embodiments with light source(s) behind at least one window element, a non-transparent part of the housing can comprise one or more openings for the window element, or—in the case of an annular window element for example—the housing can include several non-transparent parts, which are connected by the window element

The nebuliser can thus be constructed such that either the light source, or, as the case may be, the window, which is transparent to the UV radiation is fixedly and not (designately/destruction-freely) releasably connected to the housing or the housing parts of the nebuliser module which carries the oscillation element, for example by way of the electric contacts or the window, as mentioned, being fastened by a curing mass.

The housing of the nebuliser module or a non-transparent housing part/non-transparent housing parts can be present for example cast moulded parts(s) or as deep-drawn part(s) or part(s), which are manufactured in another manner.

The housing, for example, is designed in an essentially rotationally symmetrical manner about an axis. It can form a receiver for the oscillation element by way of it including a radially inward, continuous opening, which is sealingly closed by the oscillation element. At the lower side, together with the oscillation element it can for example form a beaker-like receiver (open to the bottom) for the electronics module or other components as the case may be.

In embodiments, the water receiving region can be formed, for example, by a cylinder-like or truncated-cone-like volume above the oscillation element. Thereby, the diameter of this volume can correspond roughly to the diameter of the nebuliser module, and in particular one can envisage this diameter being only moderately larger than double the radial distance of the light source(s) to the centre of the oscillation element (i.e. to the axis of the arrangement). In particular, the diameter on average at the most can be twice this double radial distance or at the most 1.8-fold or even at the most 1.6 fold. One can also envisage the water surface of the water receiving region being within this volume. An opening or cone angle of the volume to the top can, for example, be between 0° and 30°, in particular between 0° and 20°.

Such a volume can also mean that the water receiving region receives the water to be atomised in the manner of a beaker. Thereby, the water surface, from which the atomisation takes place, is clearly delimited, and it is ensured that it is completely affected by the UV beams. The light source(s) or the light coupling-in point(s) is/are then arranged along the base and/or the peripheral lateral surface (the side surface).

The terms used in this text and related to the orientation such as (“to the top”, “to the bottom” etc. are to be understood as being related to a designated normal operating condition of the apparatus, in which the oscillation element is covered by water.

Optionally, one can envisage the lateral surfaces and/or the base area (possibly without the oscillation element itself) of such a volume being partly or completely reflective (provided with a reflective coating), which further increases the efficiency of the arrangement.

### BRIEF DESCRIPTION OF THE DRAWINGS

Embodiment examples of the invention are hereinafter described in more detail by way of drawings. The drawings are partly schematic. In the drawings, the same reference numerals indicate the same or analogous elements. There are shown in:

FIG. 1 a schematic representation of a humidifier;

FIG. 2 a representation of a nebuliser module in a first embodiment, represented in a sectioned manner along the line A-A in FIG. 2b;

FIG. 2b a plan view of the nebuliser module according to FIG. 2a;

FIG. 2c a lateral view of the nebuliser module of FIGS. 2a and 2b;

FIG. 3a a representation of a nebuliser module in a second embodiment, represented in a sectioned manner along the line A-A in FIG. 3b;

FIG. 3b a plan view of the nebuliser module according to FIG. 3a;

FIG. 3c a lateral view of the nebuliser module of FIGS. 3a and 3b;

FIG. 4 a sectioned representation of the water receiving region and nebuliser module of a further humidifier;

FIG. 5a-5c views of the nebuliser (represented in each case without a circuit board cooling body) of the humidifier according to FIG. 4;

FIG. 6 a view from above, of an alternative nebuliser module for a humidifier as represented in detail in FIG. 4;

FIG. 7 a water receiving region with a nebuliser module of a further alternative embodiment;

FIGS. 8a and 8b schematic sectioned representations of a water receiving region with a nebuliser module of yet a further embodiment;

FIG. 9 a schematic sectioned representation of a water receiving region of a further embodiment;

FIGS. 10 and 11 in each case, a schematic representation of further variants;

FIG. 12 schematically, a further air humidifier with and additional water reservoir region; and

FIG. 13a-13f representations of a further humidifier with a water reservoir region.

### DETAILED DESCRIPTION OF THE INVENTION

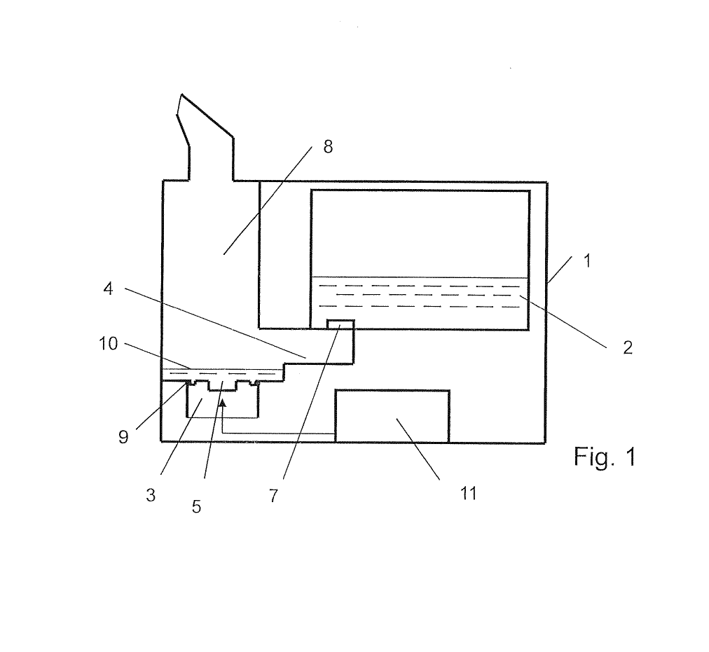

The humidifier, which is schematically represented in FIG. 1, includes a housing 1 and in the housing 1 a water store (water tank) 2 as well as a nebuliser module 3. A conduit 4 leads from the water store 2 to a water receiving region 5 above the nebuliser module 3. The outflow quantity of the water which is led from the water store 2 to the water receiving region is controlled by way of suitable means 7, and specifically such that the water level above the nebuliser module 3 is held in a roughly constant manner. These means 7 can include an electronic control or also, for example, a float that closes the outflow out of the water store, as soon as the water in the water receiving region 5 has reached a certain filling height.

The oscillation element below the water surface, in the nebuliser module 3 is brought into ultrasound oscillation on operation. Fine water droplets release from the surface on account of this. These are released to the surroundings via an outlet 8, which is chimney-like for example, wherein means (fan or likewise), which are not represented in the figure, can yet be present, by way of which a draft through the outlet is effected.

An activation unit 11 includes electronics, which for example are connected to a switch-on button of the apparatus and/or to other elements of a user interface and in normal operation includes an activation signal for the oscillation plate of the nebuliser module 3. The activation unit is thereby arranged in a dry region of the humidifier and is connected to electrodes of the oscillation element via feed-throughs 3.

The activation unit 11 can also be arranged in the receiver of the nebuliser module 3, which is formed at the lower side of the housing, so that the nebuliser module functionally also forms a monolithic unit.

The activation unit 11 can be a part of an electronics module, which operates the complete humidifier or also form such.

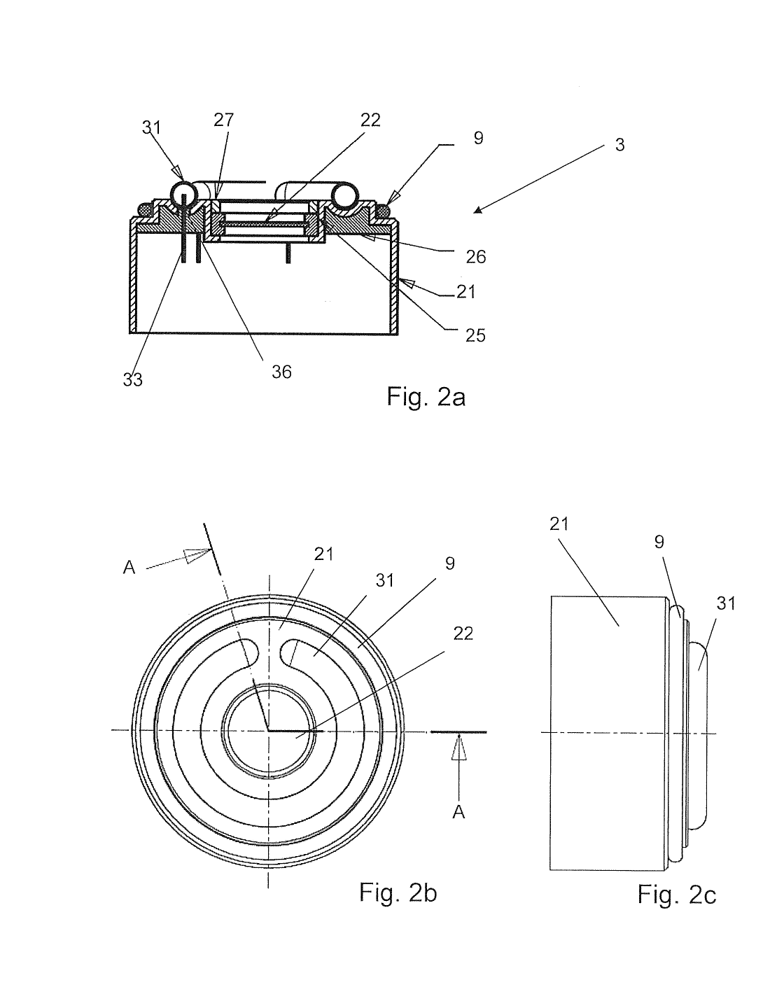

A first embodiment of a nebuliser module 3 is represented in FIGS. 2a-2c. A nebuliser module housing 21, which is open to the bottom in a beaker-like manner, together with the humidifier housing (or other components of the humidifier which define the water receiving region and possibly the outlet) defines a humid region (above the nebuliser module housing) and a dry region (below). A nebuliser module seal 9 is present for sealing to the humidifier housing or other components of the humidifier.

The nebuliser module housing 21 by way of an oscillation plate seal 25 carries an oscillation element in the form of an oscillation plate 22. The oscillation plate seal 25 is received from above into a receiver, which is formed by the nebuliser module housing. The oscillation plate seal is fixed to the top in a suitable manner, for example by way of a threaded ring 27. The oscillation plate in a manner known per se its connected to electrodes, which are not represented in the figure, are electrically contacted from the dry region and are connected to the activation unit. The oscillation element by way of applying an electric voltage deforms due to the piezoelectric effect and is thus set into oscillation by way of the application of an alternating voltage. Such oscillations are transmitted to the water surface on account of the incompressibility of the water, which is why small droplets detach there. The nebuliser module 3 acts as a water atomiser or indeed as a “nebuliser” on account of this.

An ultraviolet light source, specifically a UV tube 31 is attached at the upper side, i.e. at sides of the humid region and covered by water in the water receiving region on operation, in a manner surrounding the oscillation element. This tube annularly surrounds the oscillation plate 22. The ring which is formed by the UV tube is open at one side.

It would also be possible to use several UV tubes, for example two tubes, which are applied around the oscillation element at both sides in the manner of a half-moon, or a plurality of straight or actuate tubes which surround the oscillation element.

The UV tube 31 is electrically contacted from the housing lower side via electrical feed-throughs 33. The feed-through 33 lead through openings 36 in the nebuliser module housing 21 and through a sealing moulded mass 26, for example of a silicone or an epoxy resin or another plastic. They can optionally be combined with a feed-through (or several feed-throughs) for one or more of the electrodes of the oscillation element 22, i.e. lead-throughs for the UV light source and for an oscillation element electrode can be applied through the same opening in the housing.

On operation of the nebuliser module, apart from the oscillation element, the UV light source is also fed by the activation unit 11 by way of applying a suitable electrical voltage or a suitable voltage course. Thereby, the UV light source can be operated in a constant or intermittent manner or, for example, only after starting operation or according to a different pattern.

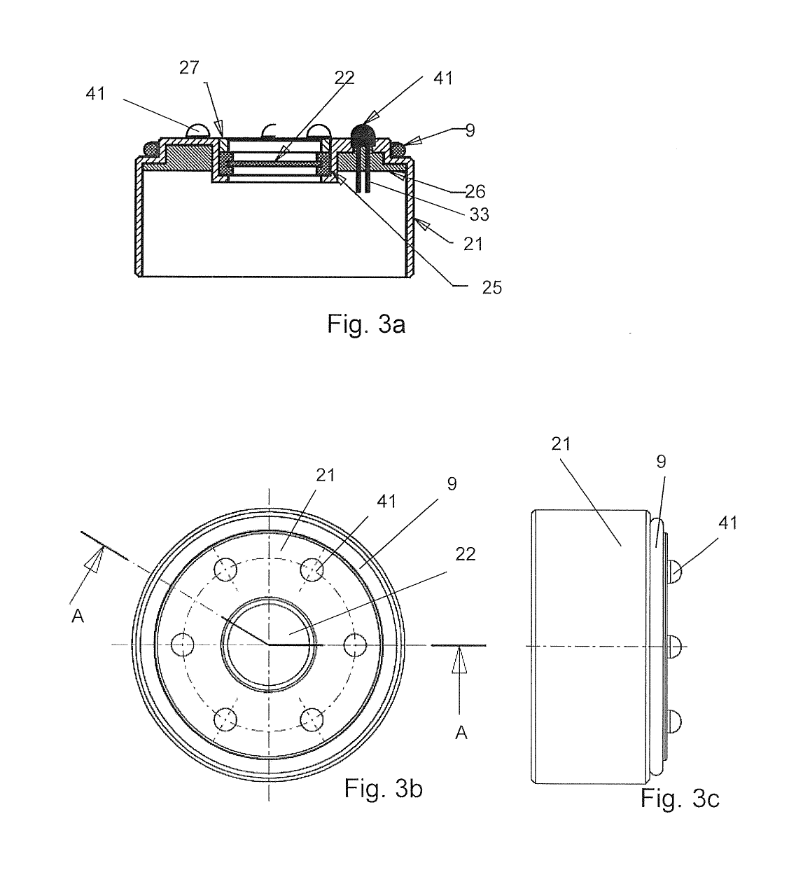

The embodiment according to FIG. 3a-3c differs from that according to FIG. 2a-2c in that UV LEDs are used as UV light sources instead of a UV tube (or several UV tunes). Six UV LEDs 41 are shown in the drawn embodiment example, and these surround the oscillation element. For this purpose, they are distributed regularly in the peripheral direction and are arranged around the oscillation element at equal radial distances.

The encasing of the UV LEDs is manufactured in a water-tight manner and this analogously applies to the first embodiment with a UV tube, since the light source will be covered by water in normal operation.

An alternative to individually encased or housed LEDs or other light sources is the use of a window element that is sufficiently transparent to UV radiation. The following embodiment examples are based on this principle.

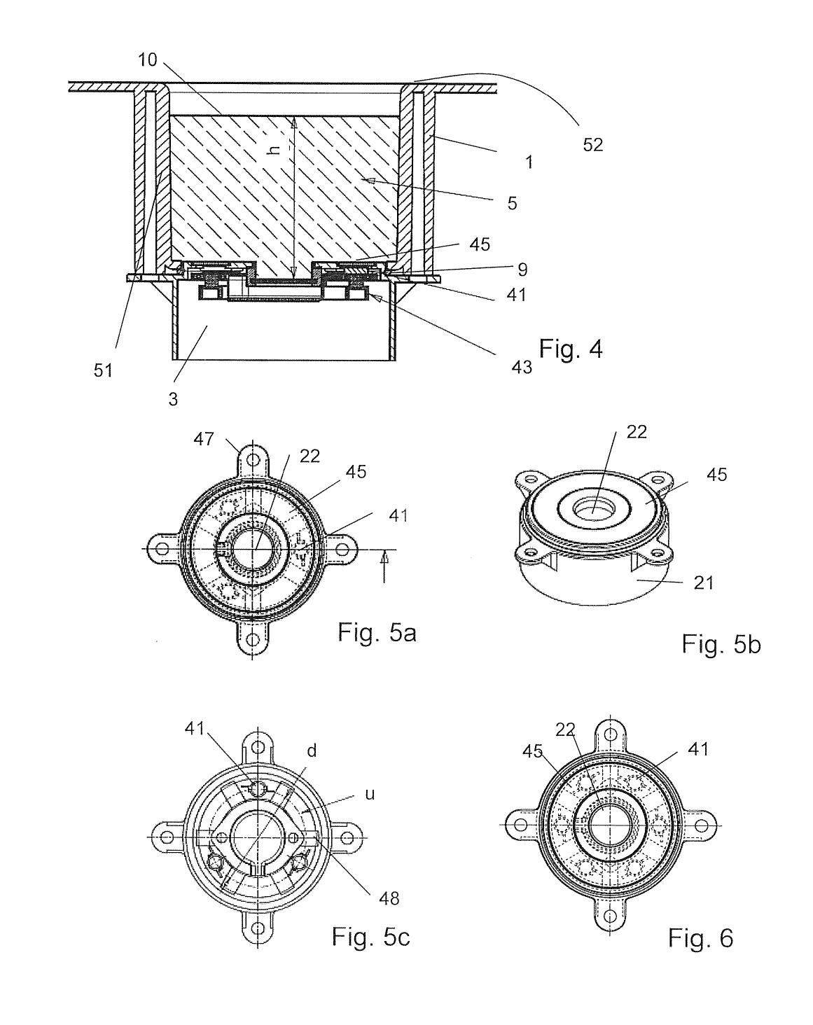

FIG. 4 shows a water receiving region 5 of a humidifier with a nebuliser module 3. The air humidifier housing 1 forms a beaker-like volume that is closed to the bottom by the nebuliser module 3 and includes a peripheral side wall 51, which conically widens in a slight manner to the top. The height h of the water covering is selected such that the water surface is located within the volume, i.e. the water level 10 lies below the upper edge 52 of the volume.

The side wall 51 is optionally reflective on the inside, so that incident ultraviolet light is reflected back into the water.

The height h of the water level 10 above the oscillation element can be selected such that the effect of the atomisation is optimised in view of the spatial conditions; and often it will lie between 30 mm and 70 mm, for example between 40 mm and 60 mm.

The nebuliser module 3, which is shown in a view from above in FIG. 5a, in a 3D view in FIG. 5b and in a view from below in FIG. 5c, is screw-fastened on the housing 1 in a fixed manner by way of fastening tongues 47, wherein a suitable seal 9 is present as in the above embodiment examples. As with the preceding embodiment examples, the module includes an oscillation plate 22 as well as suitable fastening means, sealing means and contacting means. Three UV LEDs 41 are present emitting to the upper side and these are uniformly distributed in the peripheral direction and are arranged at the same distance to the axis (in the middle of the oscillation plate 22 and perpendicular to this). A corresponding circle with a diameter d is drawn in FIG. 5c, and this diameter d for example is between 35 and 55 mm with apparatus of an average size for household use.

The LEDs are arranged directly on a circuit board in a non-housed manner and are contacted through this circuit board, for example by SMD technology or also by way of vias from the rear side of the circuit board. Other types of contacting, for example directly via cable—are also not ruled out.

The nebuliser module housing 21 above the LEDs includes an annular window 45, which is connected to the metallic housing parts in a water-tight manner, and this window, for example, is of synthetic quartz glass, sapphire glass, calcium fluoride or another material that is solid at room temperature and transparent to UVC radiation.

A cooling body 43 can yet be recognised at the lower side in FIG. 4, and this is connected to the LEDs in a thermally conductive manner (wherein each LED can have its own cooling body), or a common, for example annularly peripheral cooling body can be present for all LEDs. Such a cooling body can be connected to the lower side of the LED/LEDs in a direct manner by way of suitable recesses in the circuit board, or one can use a circuit board, for example based on aluminium, which at least in regions is well thermally conductive and which leads the arising heat to its rear side in an efficient manner. The cooling body/bodies is/are then connected directly to the circuit board.

Supplementary or alternatively to the cooling body/cooling bodies, one can ensure that a draft prevails at the lower side—for example with a fan which is present in any case.

Models that transport excess heat away to the upper side and lead it to the water are also conceivable per se, for example via windows 45 that are well thermally conductive, or designs that lead the heat to metallic housing parts.

Webs 48 are yet visible in FIGS. 5a and 5c, and these connect the outer part of the nebuliser module housing 31 to an inner part which holds the oscillation plate 22 and mechanically hold together the housing independently of the window. The webs are arranged between the windows and the circuit board in the drawn embodiment. They can be of plastic or metallic.

The embodiment according to FIG. 6 differs from that according to FIGS. 5a-5c by way of the number of LEDs. Six LEDs 41 are present, which are arranged on an annularly peripheral circuit board or on a plurality of separate circuit boards, likewise by SMD technology.

The use of an individual window in each case per LED instead of an annularly peripheral window is also possible in configurations such as those of FIG. 4-6.

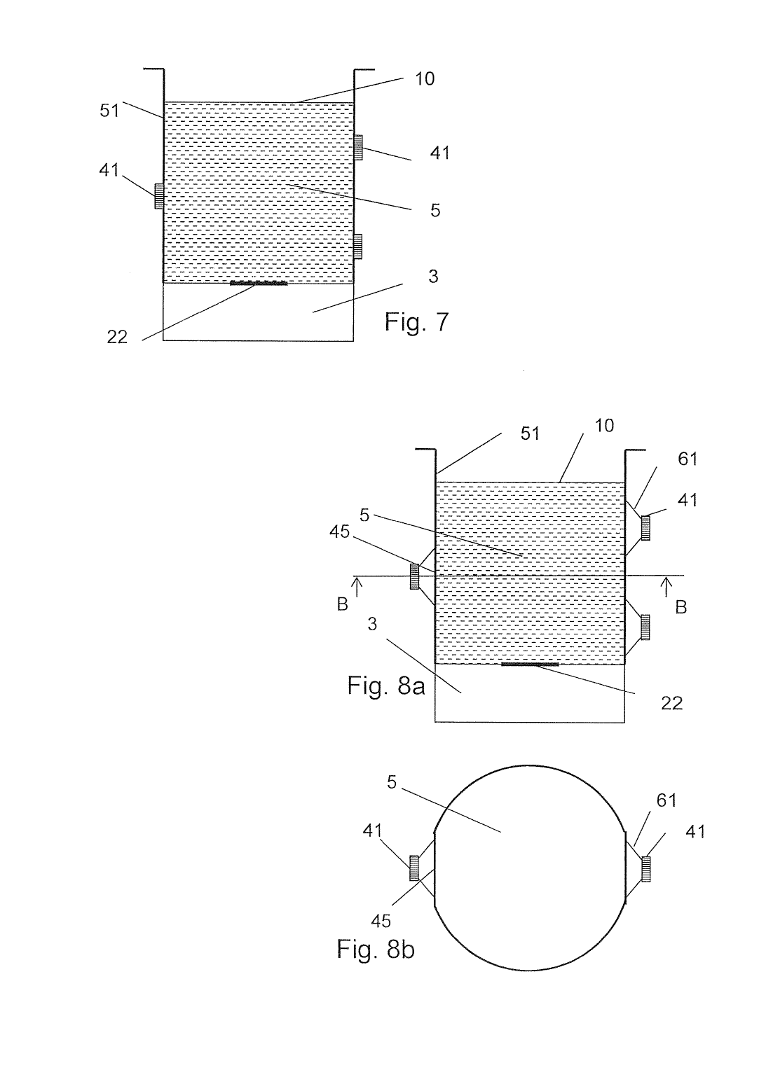

FIG. 7 shows an embodiment, with which the water receiving region 5 is likewise formed by a beaker-like volume. In contrast to the embodiment according to FIG. 4, the UV LED light sources 41 however are not arranged along the base, but along the side walls 51 of the beaker. The humidifier housing, which forms the beaker-like volume, is provided with transparent inserts in the region of the UV-LED light sources 41. Water impermeable feed-throughs can alternatively be present, and the UV LED light sources are encased in a water-tight manner.

In the represented example, as a whole three UV LEDs 41 are arranged on two sides that are opposite one another and are arranged at different heights. Other arrangements are also possible, for example with LEDs that are distributed uniformly along the peripheral direction.

The variant according to FIGS. 8a and 8b (FIG. 8b very schematically shows a representation of the region sectioned along the plane B-B in FIG. 8a) envisages the beaker-like volume not being rotationally symmetrical, but having the shape of a cylinder with lateral flattenings (flattened portions), wherein the UV LEDs 41 are arranged at a lateral distance to these flattened portions. The humidifier housing with UV-permeable discs is provided in the region of the flattenings, and these discs can be designed in a strip like manner or for example around the LEDs in a disc-like manner.

In the shown example, the UV LEDs 41 are moreover arranged at a distance to the beaker-like volume, wherein light deflection means 61 can yet be present, and these reflect laterally emitted light into the water receiving region 5 and can influence the radiation emitting characteristics.

The features “non-rotational-symmetrical and “distance of the UV LEDs 41 to the volume” are independent of one another, i.e. can be realised in each case per se or also in combination.

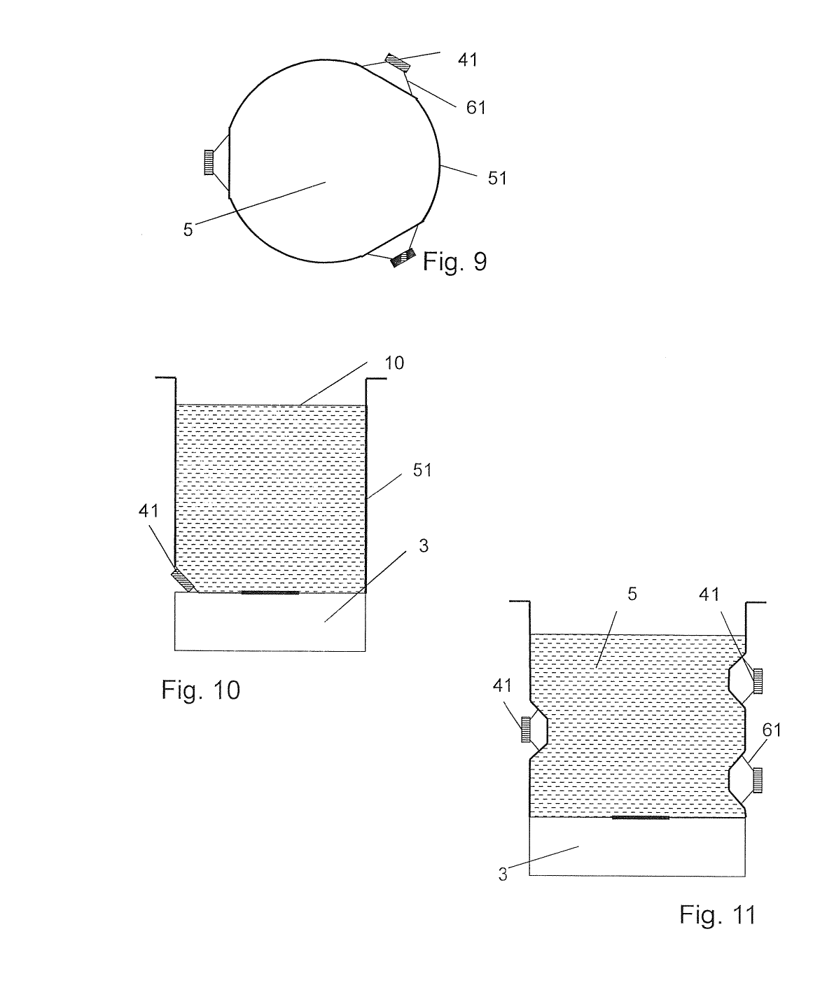

FIG. 9 schematically shows a further possible arrangement of three UV LEDs along the peripheral direction. The UV-LEDs are arranged at regular angular distances, i.e. are distributed uniformly about the peripheral direction. Thereby, the light sources can be arranged at one and the same height but also at different heights. An arrangement at different heights—for example analogously to FIG. 7 and FIG. 8a—can even be advantageous, since a particularly uniform illumination of the water receiving region results.

In the embodiment according to FIG. 9, the volume is also not rotationally symmetrical about the vertical axis, and the UV LEDs 41 are arranged at a distance to the volume. Both features are optional in each case.

FIG. 10 as a further variant represents an arrangement of the UV LED light source 41 at the lower side, but peripherally and tilted, so that the UV radiation is predominantly emitted upwards and to the middle.

An arrangement of several UV LED light sources along the peripheral direction and/or the combination with differently arranged UV LED light sources and/or the provision of a distance to the water receiving region are also conceivable in the variant according to FIG. 10.

FIG. 11 shows yet a variant, with which the water receiving region is likewise not rotationally-symmetrical and moreover is also not cylindrical or conical, by way of an indentation being present in an otherwise cylindrical or conical region per light source 41, from which indentation the UV light is emitted into the water receiving region 5.

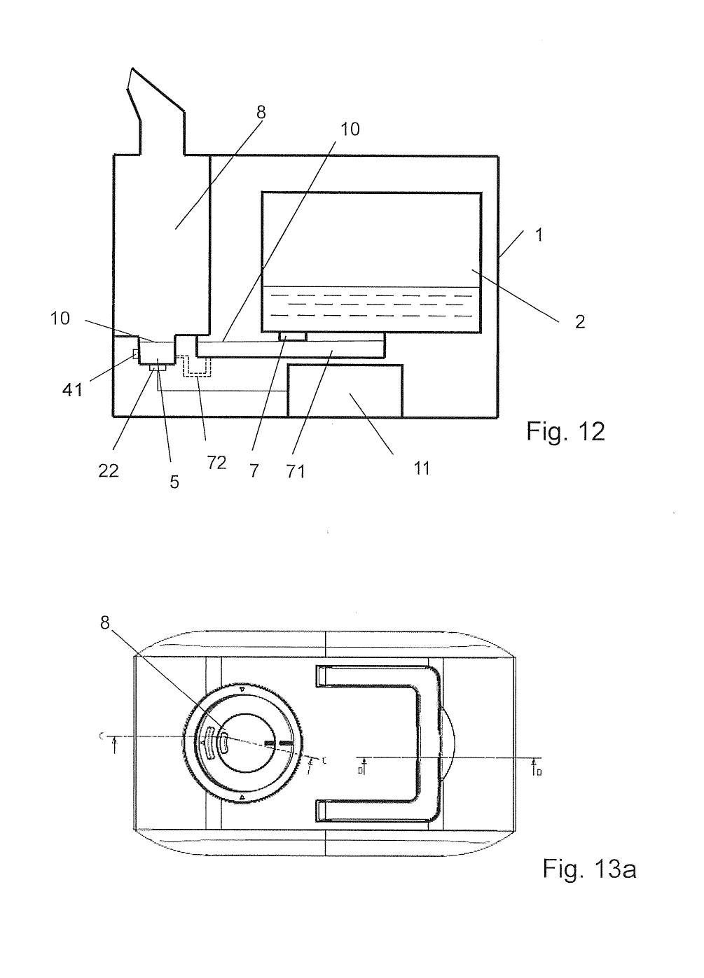

FIG. 12 shows the principle of a humidifier of the type being discussed here, with which a water reservoir region 71 is present additionally to the water receiving region 5 and has the same water level 10 as the water receiving region. The water reservoir region 71 is supplied with water by the water tank 2. The means 7 of controlling the flow of water out of the water tank into the water reservoir region is shown schematically here as a means functioning according to the chicken drinking trough principle. Additionally—as in all embodiments—the means can be designed according to the Swiss Patent application 01 622/13 and be provided, for example, with a muffler. The Swiss patent application 01 622/13 is expressly referred to here, with regard to the control of the water level with the chicken drinking trough principle as well as concerning the possibility of the provision of a muffler.

The passage 72 from the water reservoir region into the water receiving region is designed such that the water level in the water receiving region always corresponds to the water level in the water reservoir. Here, it is represented as a flexible tube or pipe, but it can alternatively also be formed by a channel in the housing or by an opening in a wall separating the regions. The cross section of the passage is often very small in relation to the dimensions of the water receiving region 5 designed in a beaker-like manner, for example at the most the active area of the oscillation plate or maximal 2 cm² or maximal 1 cm² or maximal 0.5 cm² or 0.2 cm² or less.

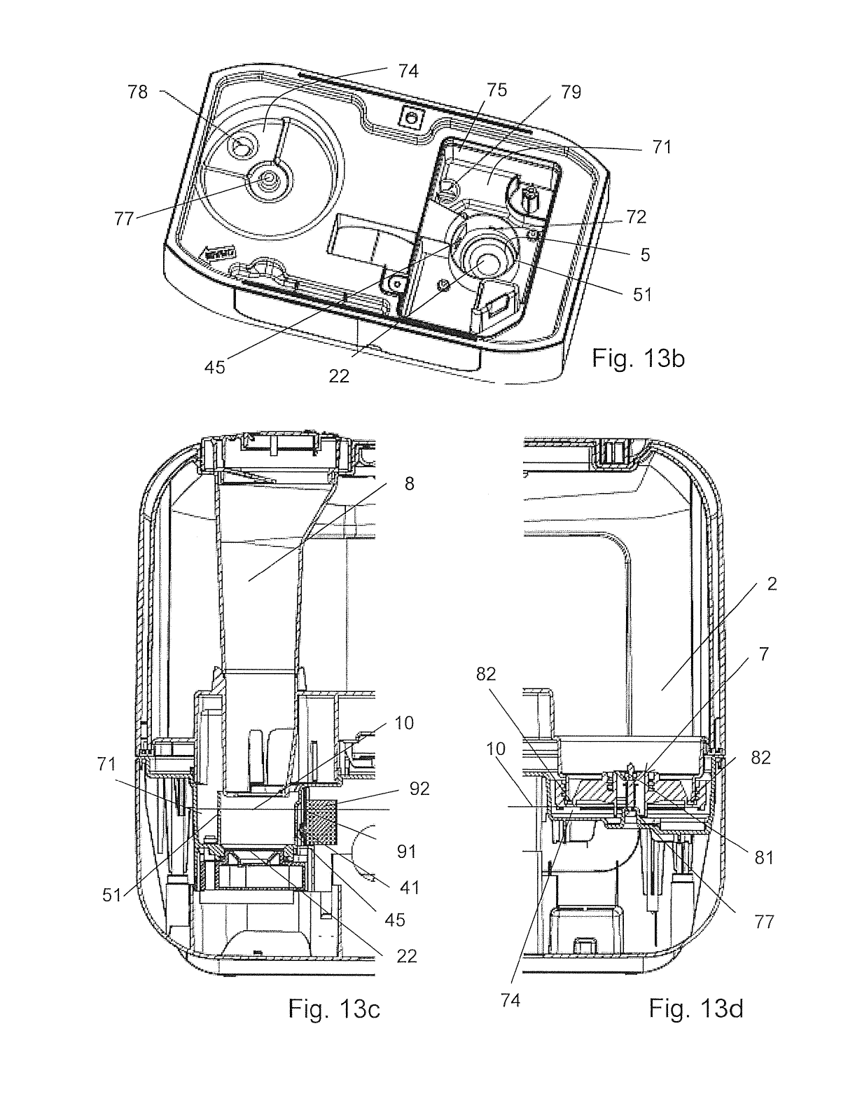

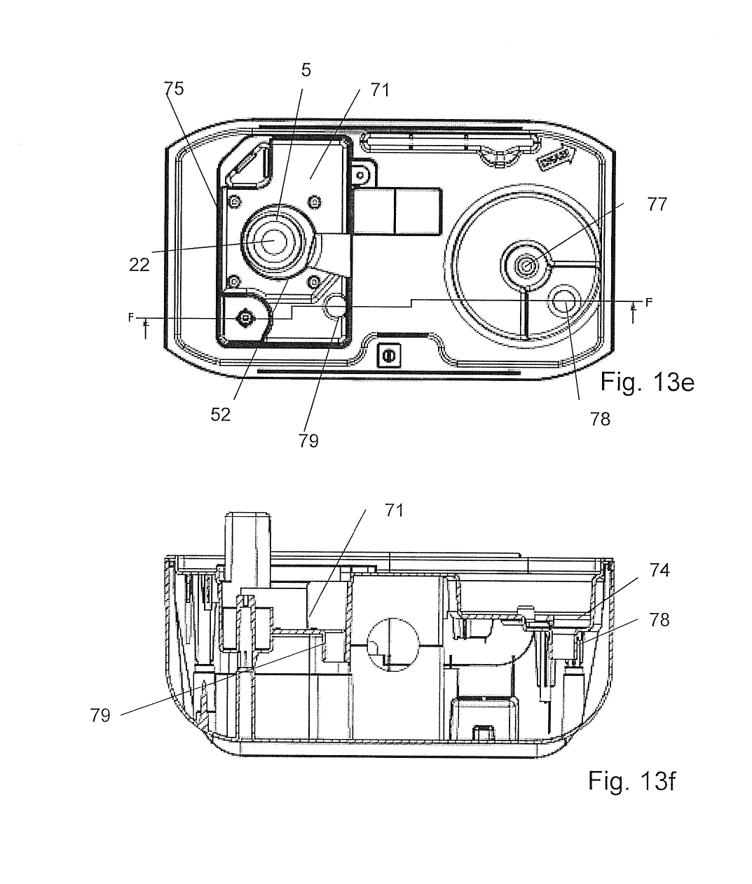

FIGS. 13a to 13f show an embodiment of an air humidifier with a water reservoir region. Thereby, FIG. 13a shows a view from above, FIG. 13b a perspective view of a lower region of the humidifier, FIGS. 13c and 13d the respective regions of the humidifier, sectioned along the planes C-C and D-D respectively in FIG. 13a, FIG. 13e a view of the lower region of from above and FIG. 13f this region sectioned along the line F-F in FIG. 13e.

In FIG. 13b, one can see that the water reservoir region 71 is designed surrounding the water receiving region. The passage 72 is formed by a small opening in the side wall 51 of the water receiving region.

Only a single UV-LED light source 41 is necessary in the represented embodiment due to the limited size of the beaker-like volume forming the water receiving region 5. This is arranged below the water level such that it is couples UVC light into the water reservoir region through a window 45—for example of quartz glass. In FIG. 13c one can also see a circuit board 91, on which the UV-LED chip 41 is assembled and contacted, as well as a cooling body 92 for cooling this chip 41. The housing of the humidifier is shaped such that the light source and the contactings etc. of this are arranged on the side that is away from the water, i.e. is the water-free region is led laterally to the water receiving region, at the location of the light source, as one can see for example in FIG. 13.

An arrangement of the at least one light source on the lower side of the water receiving region 5 would also be possible in embodiments with an additional water reservoir region 71 as those of FIGS. 12 and 13, wherein the lateral arrangement has the advantage that the diameter of the water receiving region and thus of the water region as such can be kept small, since no additional space is required laterally of the transducer at the lower side of the water receiving region.

Apart from the water reservoir region, yet a separate tank outflow region 74, which is likewise designed as a communicating vessel, is also present in the embodiment that is shown here. The water level 10 in this is always held at a certain defined level by the means 7 of the tank 7. The water reservoir region 71 and the tank outflow region 74 are communicatingly connected to one another, via a tubing, which on the one hand is connected to an outflow region connection stub 78 and on the other hand to a water reservoir region inflow stub 79. This flexible tubing is not shown in the figures. The (flexible) tubing or a comparable connection (pipe, other channel) can optionally be provided with a heating module, inasmuch as a heating of the fluid to be atomised is desired.

As in all embodiments, the humidifier here can also be provided with a removable tank 2, which automatically closes on removal. For this purpose, the tank here includes a self-closing valve 81, which is automatically opened by a plunger 77 of the housing as soon as the tank is placed. Here too, the control of the water level is effected according to the chicken drinking trough principle, by way of air firstly being able to post-flow into the tank when the water drops below the level of a lateral delimitation 82. This principle is described in a more detailed manner in the mentioned patent application 01 622/13.

Many further embodiments are also conceivable.

1. An atomiser humidifier comprising a water store and an oscillation element that can be excited into oscillation and that is covered by water in normal operation of the humidifier, as well as with a device for feeding water out of the water store to a water receiving region above the oscillation element such that the water fills the water receiving region up to a water level, wherein at least one ultraviolet light source, which is coupled to the water receiving region so as to couple ultraviolet light from a position below the water level into the water in the water receiving region.

2. The atomiser humidifier according to claim 1, wherein a nebuliser module with the oscillation element, wherein the nebuliser module comprises a nebuliser module housing, wherein the at least one ultraviolet light source is present on the nebuliser module and is fastened directly or via a carrier, on the nebuliser module housing.

3. The atomiser humidifier according to claim 2, wherein the nebuliser module housing separates a first side facing the water from a second side that is away from the water, wherein the ultraviolet light source or the ultraviolet light sources are arranged on the first side and can be contacted through the nebuliser module housing via electrical feed-throughs, wherein the electrical feed-throughs are connected to the housing in a watertight manner.

4. The atomiser humidifier according to claim 2, wherein the nebuliser module housing to the top comprises a window that is transparent to ultraviolet light, is connected to further housing parts in a watertight manner and below which the ultraviolet light source or at least one of the ultraviolet light sources is arranged.

5. The atomiser humidifier according to claim 1, wherein the ultraviolet light source or the ultraviolet light sources surrounds/surround the oscillation element at least partly.

6. The atomiser humidifier according to claim 1, wherein the at least one ultraviolet light source is a UV LED.

7. The atomiser humidifier according to claim 6, wherein a plurality of UV LEDs are present and are arranged around the oscillation element.

8. The atomiser humidifier according to claim 1, wherein at least one ultraviolet light source is a UV gas discharge lamp.

9. The atomiser humidifier according to claim 1, wherein the oscillation element is an oscillation plate that defines a plane, and that the at least one light source at the most is arranged above the plane by 1 cm.

10. The atomiser humidifier according to claim 1, wherein the water receiving region is formed by a beaker-like volume above the oscillation element, wherein the water level in the water receiving region is within the beaker-like volume.

11. The atomiser humidifier according to claim 10, wherein side walls of the volume are reflective.

12. The atomiser humidifier according to claim 10 , wherein the ultraviolet light source or at least one of the ultraviolet light sources is/are arranged along the side walls of the volume.

13. The atomiser humidifier according to claim 12, wherein a peripheral side wall of the volume comprises a window, through which light, which is radiated from the ultraviolet light source or at least one of the ultraviolet light sources, can be coupled into the water receiving region.

14. The atomiser humidifier according to claim 10, comprising a water reservoir region, which is coupled via a passage below the water level to the water receiving region, such that the water level in the water receiving region and a water level in the water reservoir region are identical at all times, wherein the water gets from the water store via the water reservoir region into the water receiving region.

15. The atomiser humidifier according to claim 14, wherein a base area of the water reservoir region including possible further water-filled regions which lie outside the water receiving region and which are communicatingly connected to the water reservoir region in a direct or indirect manner, at the height of the water level is at least double the base area of the water receiving region at the height of the water level.

16. The atomiser humidifier according to claim 10, wherein an average angle of a peripheral side wall of the volume to the vertical at the height of the water level is 20° at the most.

17. A nebuliser module for an atomiser humidifier according to claim 1, for installation into a housing of the atomiser humidifier, comprising a nebuliser module housing and an oscillation element that can be excited into oscillation and which is designed to be covered by water in normal operation of the humidifier, wherein the nebuliser module comprises at least one ultraviolet light source fastened on the nebuliser module housing.
